(19) United States
(12) Patent Application Publication
(10) Pub. No.: US 2022/0306364 A1
(43) Pub. Date: Sep. 29, 2022

(54) WELDED FILM LAMINATE, ULTRASONIC WELDING MACHINE, AND METHOD FOR PRODUCING WELDED FILM LAMINATE

(71) Applicant: SEIKO EPSON CORPORATION, Tokyo (JP)

(72) Inventors: Yuto MOMOSE, Matsumoto-shi (JP); Jun TAKIZAWA, Azumino-shi (JP)

(21) Appl. No.: 17/703,179

(22) Filed: Mar. 24, 2022

(30) Foreign Application Priority Data
Mar. 26, 2021 (JP) 2021-052919

(51) Int. Cl. B65D 75/26; B65B 51/22; B32B 27/08; B32B 7/12

(52) U.S. Cl. CPC B65D 75/26; B65B 51/225; B32B 27/08; B32B 7/12; B32B 2553/00; B32B 2250/03; B32B 2250/24; B32B 2307/31

(57) ABSTRACT

In a welded film laminate 1, a second protective layer 14 of a first film substrate 2 and a third protective layer 22 of a second film substrate 3 are welded and fixed to each other by an adhesive layer melted out from at least one of a first adhesive layer 11 to a fourth adhesive layer 27 via a first melted penetration portion 6a of the second protective layer 14 and/or a second melted penetration portion 6b of the third protective layer 22. A welding fixed portion 6c is surrounded in a plan view by a first welded portion 33 in which the first adhesive layer 11 and a second adhesive layer 15 of the first film substrate 2 are welded to each other and/or a second welded portion 35 in which a third adhesive layer 23 and the fourth adhesive layer 27 of the second film substrate 3 are welded to each other.

The present application is based on, and claims priority from JP Application Serial Number 2021-052919, filed Mar. 26, 2021, the disclosure of which is hereby incorporated by reference herein in its entirety.

### BACKGROUND

### 1. Technical Field

The present disclosure relates to a welded film laminate, an ultrasonic welding machine, and a method for producing a welded film laminate.

### 2. Related Art

A bag made of a synthetic resin film is widely used for packaging articles. JP-A-2011-11784 discloses an example in which a small piece of synthetic resin film is welded to a bag made of a synthetic resin film. Accordingly, an operator overlaps the bag and the small piece, and presses and welds the bag and the small piece by an ultrasonic vibrating horn. When the overlapped films are ultrasonically vibrated by the horn, the films are heated and welded by frictional heat. As the synthetic resin film, a vinylidene chloride-based resin or an olefin-based resin, which can be easily heat-welded, has been used. Since the film is easily torn at a welded portion, the small piece is welded to the bag in order to easily open the bag.

In order to strengthen the bag, a bag formed of a sheet including two or more layers of synthetic resin film is widely used. The sheet includes an adhesive layer and a protective layer. The adhesive layer is disposed on an inner side of the bag, and the protective layer is disposed on an outer side of the bag. For example, polyethylene or cast polypropylene (CPP) is used for the adhesive layer, and nylon or vapor-deposited polyethylene terephthalate (PET) is used for the protective layer. The adhesive layer has a melting point lower than that of the protective layer and can be thermally welded easily. Therefore, a bag can be easily formed. The protective layer is less likely to be damaged and has a higher melting point than the adhesive layer.

The adhesive layers formed on an inner side of the films to be welded are welded to each other, thereby maintaining airtightness of the inside of the bag. Regarding welded packages, further welding and fixing of bags to each other have been contrived in consideration of necessity of size reduction, compactness, and handling properties in distribution and packaging.

In order to weld the bags while maintaining the airtightness, it is necessary to weld the protective layers on the outer side of the bags. There is a problem that when the ultrasonic vibrating horn is pressed against the overlapped bags to raise a temperature of the protective layers to a melting point, the bags are melted and opened with a hole, and it is difficult to secure airtightness of the bags as a package.

### SUMMARY

A welded film laminate includes: a first film substrate including a first film in which a first protective layer and a first adhesive layer having a melting point lower than that of the first protective layer are laminated, and a second film in which a second protective layer and a second adhesive layer having a melting point lower than that of the second protective layer are laminated; and a second film substrate including a third film in which a third protective layer and a third adhesive layer having a melting point lower than that of the third protective layer are laminated, and a fourth film in which a fourth protective layer and a fourth adhesive layer having a melting point lower than that of the fourth protective layer are laminated, parts of the adhesive layers being welded to one another and sealed such that an article to be packaged is packaged between the first protective layer and the second protective layer of the first film substrate and/or between the third protective layer and the fourth protective layer of the second film substrate. The second protective layer of the first film substrate and the third protective layer of the second film substrate are welded and fixed to each other by an adhesive layer melted out from at least one of the first adhesive layer to the fourth adhesive layer via a first melted penetration portion of the second protective layer and/or a second melted penetration portion of the third protective layer. A welding fixed portion in which the second protective layer and the third protective layer are welded and fixed to each other is surrounded in a plan view by a first welded portion in which the first adhesive layer and the second adhesive layer of the first film substrate are welded to each other and/or a second welded portion in which the third adhesive layer and the fourth adhesive layer of the second film substrate are welded to each other.

A welded film laminate includes: a first film in which a first protective layer and a first adhesive layer having a melting point lower than that of the first protective layer are laminated; and a second film in which a second protective layer and a second adhesive layer having a melting point lower than that of the second protective layer are laminated, a part of the first adhesive layer and a part of the second adhesive layer being welded to each other and sealed in a state in which an article to be packaged is packaged between the first film and the second film. The laminated first film and the second film are bent such that the second protective layer is located on an inner side and is bent into two parts facing each other, and one part and the other part of the bent second protective layer, which face each other, are welded and fixed by an adhesive layer melted out from at least one of the first adhesive layer and the second adhesive layer through a first melted penetration portion of the one part of the second protective layer and/or a second melted penetration portion of the other part of the second protective layer. A first welded portion in which the first adhesive layer and the second adhesive layer are welded to each other is provided on a side closer to the one part of the second protective layer, and a second welded portion in which the first adhesive layer and the second adhesive layer are welded to each other is provided on a side closer to the other part of the second protective layer side, the first welded portion and the second welded portion surrounding, in a plan view, a welding fixed portion in which one part and other part of the second protective layer are welded and fixed to each other.

An ultrasonic welding machine includes: a horn having a vibrating surface configured to be in contact with an object to be welded; a vibrating unit configured to ultrasonically vibrate the horn; a vibrator configured to drive the vibrating unit; and a horn receiver configured to hold the object to be welded together with the horn. The horn receiver has a recess or a hole in a receiving surface to be in contact with the object to be welded, the recess or hole having an area smaller than an area of the vibrating surface.

A method for manufacturing a welded film laminate includes: preparing a first film substrate including a first film in which a first protective layer and a first adhesive layer having a melting point lower than that of the first protective layer are laminated, and a second film in which a second protective layer and a second adhesive layer having a melting point lower than that of the second protective layer are laminated, the first adhesive layer and the second adhesive layer each including a part welded to each other; preparing a second film substrate including a third film in which a third protective layer and a third adhesive layer having a melting point lower than that of the third protective layer are laminated, and a fourth film in which a fourth protective layer and a fourth adhesive layer having a melting point lower than that of the fourth protective layer are laminated, the third adhesive layer and the fourth adhesive layer each including a part welded to each other; arranging the first film substrate and the second film substrate in a manner overlapping each other between a horn having a vibrating surface and a horn receiver having a recess or a hole in a receiving surface corresponding to the vibrating surface; heating the first film substrate and the second film substrate by vibration of the horn in a state in which the first film substrate and the second film substrate are held between the vibrating surface and the receiving surface, such that a portion corresponding to the recess or the hole has a temperature higher than a portion corresponding to the periphery of the recess or the hole; forming, at the portion corresponding to the recess or the hole, a welding fixed portion welded and fixed by an adhesive layer melted out from a part of any one of the first adhesive layer to the fourth adhesive layer via a first melted penetration portion penetrated by melting the first protective layer and/or the second protective layer of the first film substrate, and/or a second melted penetration portion penetrated by melting the third protective layer and/or the fourth protective layer of the second film substrate; and forming, at the portion corresponding to the periphery of the recess or the hole, a first welded portion in which the first adhesive layer and the second adhesive layer are welded to each other, and/or a second welded portion in which the third adhesive layer and the fourth adhesive layer are welded to each other, the first welded portion and the second welded portion surrounding the welding fixed portion.

A method for manufacturing a welded film laminate includes: preparing a welded film laminate including a first film in which a first protective layer and a first adhesive layer having a melting point lower than that of the first protective layer are laminated, and a second film in which a second protective layer and a second adhesive layer having a melting point lower than that of the second protective layer are laminated, a part of the first adhesive layer and a part of the second adhesive layer being welded to each other and sealed in a state in which an article to be packaged is packaged between the first film and the second film; bending the welded film laminate such that the second protective layer is located on an inner side and is bent into two parts facing each other; disposing one part and the other part of the bent second protective layer, which are overlapped in a manner of facing each other, between a horn having a vibrating surface and a horn receiver having a recess or a hole in a receiving surface corresponding to the vibrating surface; heating the first film and the second film by vibration of the horn in a state in which the overlapped one part and other part of the second protective layer are held between the vibrating surface and the receiving surface, such that a portion corresponding to the recess or the hole has a temperature higher than a portion corresponding to the periphery of the recess or the hole; forming, at the portion corresponding to the recess or the hole, a welding fixed portion welded and fixed by an adhesive layer melted out from a part of any one of the first adhesive layer and the second adhesive layer via a first melted penetration portion penetrated by melting the one part of the second protective layer and/or a second melted penetration portion penetrated by melting the other part of the second protective layer; and forming, at the portion corresponding to the periphery of the recess or the hole, a first welded portion in which the first adhesive layer and the second adhesive layer are welded to each other on a side closer to the one part of the second protective layer, and/or a second welded portion in which the first adhesive layer and the second adhesive layer are welded to each other on a side closer to the other part of the second protective layer, the first welded portion and the second welded portion surrounding the welding fixed portion in a plan view.

### BRIEF DESCRIPTION OF THE DRAWINGS

FIG. 1 is a schematic perspective view showing a configuration of a welded film laminate according to a first embodiment.

FIG. 2 is a schematic cross-sectional side view of a first film substrate.

FIG. 3 is a schematic cross-sectional side view of a second film substrate.

FIG. 4 is a schematic cross-sectional side view of the first film substrate.

FIG. 5 is a schematic cross-sectional side view of the second film substrate.

FIG. 6 is a schematic cross-sectional side view of a main part for illustrating a third welded portion.

FIG. 7 is a block diagram showing a configuration of an ultrasonic welding machine.

FIG. 8 is a schematic plan view of a horn.

FIG. 9 is a schematic plan view of a horn receiver.

FIG. 10 is a flowchart of a method for manufacturing a welded film laminate.

FIG. 11 is a diagram for illustrating an example of operating conditions of the ultrasonic welding machine.

FIG. 12 is a diagram for illustrating levels of thicknesses of an adhesive layer, a surface layer, and an intermediate layer.

FIG. 13 is a diagram for illustrating an influence of a hole diameter of a third hole.

FIG. 14 is a diagram for illustrating an influence of the hole diameter of the third hole.

FIG. 15 is a diagram for illustrating an influence of the thickness of the intermediate layer.

FIG. 16 is a diagram for illustrating an influence of the thickness of the intermediate layer.

FIG. 17 is a schematic perspective view showing a configuration of a welded film laminate according to a second embodiment.

FIG. 18 is a schematic cross-sectional side view of a main part for illustrating a third welded portion.

FIG. 19 is a flowchart of a method for manufacturing the welded film laminate.

### DESCRIPTION OF EXEMPLARY EMBODIMENTS

### First Embodiment

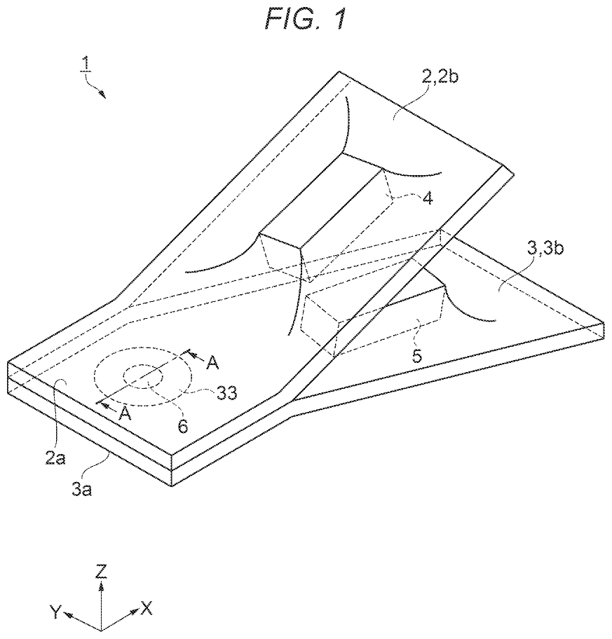

In the present embodiment, characteristic examples of the welded film laminate and the method for manufacturing the welded film laminate will be described. As shown in FIG. 1, the welded film laminate 1 includes a first film substrate 2 as an object to be welded and a second film substrate 3 as an object to be welded. The first film substrate 2 and the second film substrate 3 have a bag shape and are sealed in an airtight state.

A first article to be packaged 4 is housed inside the first film substrate 2 as an article to be packaged. A second article to be packaged 5 is housed inside the second film substrate 3 as an article to be packaged. An inside the first film substrate 2 and an inside the second film substrate 3 are depressurized. The first article to be packaged 4 and the second article to be packaged 5 are not to be wetted even if the welded film laminate 1 is put into water. One of the first article to be packaged 4 and the second article to be packaged 5 may be housed in the welded film laminate 1 alone.

The first film substrate 2 and the second film substrate 3 are rectangular in a plan view. One end of the first film substrate 2 in a longitudinal direction is referred to as a first end 2a. The other end of the first film substrate 2 in the longitudinal direction is referred to as a second end 2b. One end of the second film substrate 3 in the longitudinal direction is referred to as a third end 3a. The other end of the second film substrate 3 in the longitudinal direction is referred to as a fourth end 3b.

The first article to be packaged 4 is close to the second end 2b and is far from the first end 2a. The second article to be packaged 5 is close to the fourth end 3b and is far from the third end 3a.

A part of the first film substrate 2 on a first end 2a side and a part of the second film substrate 3 on a third end 3a side overlap each other. A third welded portion 6 is formed at a location where the first film substrate 2 and the second film substrate 3 overlap each other. At the third welded portion 6, the first film substrate 2 and the second film substrate 3 are welded to each other.

In a plane where the first film substrate 2 and the second film substrate 3 are welded to each other, the longitudinal direction of the first film substrate 2 and the second film substrate 3 is defined as an X direction, and a width direction thereof is defined as a Y direction. A thickness direction of the first film substrate 2 at the location where the first film substrate 2 and the second film substrate 3 are welded to each other is defined as a Z direction.

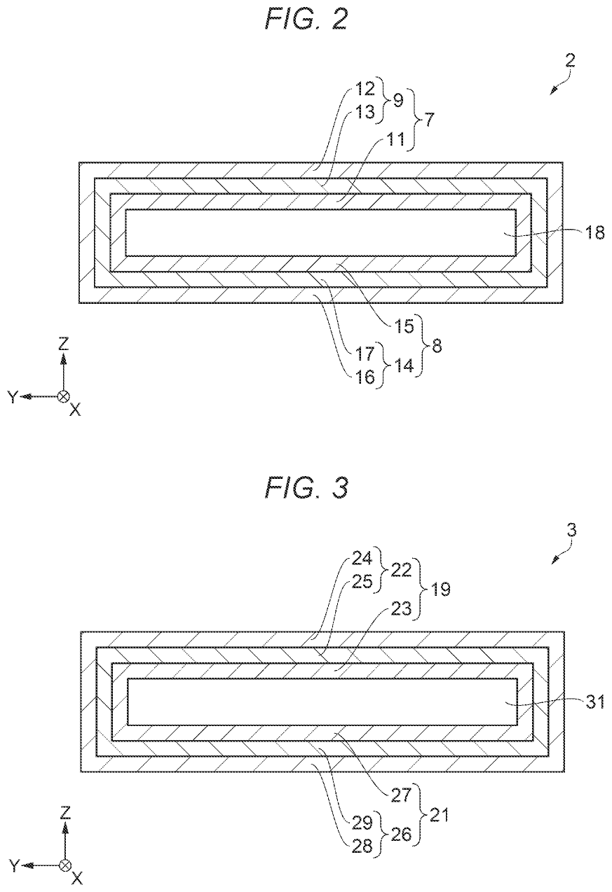

FIG. 2 is a cross-sectional view of the first film substrate 2 as viewed from a negative X direction. As shown in FIG. 2, the first film substrate 2 includes a first film 7 and a second film 8. The first film 7 is disposed mainly in a positive Z direction of the first film substrate 2. The second film 8 is disposed mainly in a negative Z direction of the first film substrate 2. The first film 7 and the second film 8 are connected to each other in a positive Y direction and a negative Y direction of the first film substrate 2. The first film substrate 2 has a tubular shape.

In the first film 7, a first protective layer 9 and a first adhesive layer 11 as an adhesive layer are laminated. The first protective layer 9 is located on an outer side. The first adhesive layer 11 is located on an inner side. In the first protective layer 9, a first surface layer 12 and a first intermediate layer 13 are laminated. The first intermediate layer 13 facilitates adhesion of the first adhesive layer 11 and the first surface layer 12. The first adhesive layer 11 has a melting point lower than that of the first protective layer 9.

In the second film 8, a second protective layer 14 and a second adhesive layer 15 as an adhesive layer are laminated. The second protective layer 14 is located on an outer side. The second adhesive layer 15 is located on an inner side. In the second protective layer 14, a second surface layer 16 and a second intermediate layer 17 are laminated. The second intermediate layer 17 facilitates adhesion of the second adhesive layer 15 and the second surface layer 16. A first internal space 18, which is an internal space of the first film substrate 2, is in an airtight state. The second adhesive layer 15 has a melting point lower than that of the second protective layer 14.

FIG. 3 is a cross-sectional view of the second film substrate 3 as viewed from the negative X direction. As shown in FIG. 3, the second film substrate 3 includes a third film 19 and a fourth film 21. The third film 19 is disposed mainly in the positive Z direction of the second film substrate 3. The fourth film 21 is disposed mainly in the negative Z direction of the second film substrate 3. The third film 19 and the fourth film 21 are connected to each other in the positive Y direction and the negative Y direction of the second film substrate 3. The second film substrate 3 has a tubular shape.

In the third film 19, a third protective layer 22 and a third adhesive layer 23 as an adhesive layer are laminated. The third protective layer 22 is located on an outer side. The third adhesive layer 23 is located on an inner side. In the third protective layer 22, a third surface layer 24 and a third intermediate layer 25 are laminated. The third intermediate layer 25 facilitates adhesion of the third adhesive layer 23 and the third surface layer 24. The third adhesive layer 23 has a melting point lower than that of the third protective layer 22.

In the fourth film 21, a fourth protective layer 26 and a fourth adhesive layer 27 as an adhesive layer are laminated. The fourth protective layer 26 is located on an outer side. The fourth adhesive layer 27 is located on an inner side. In the fourth protective layer 26, a fourth surface layer 28 and a fourth intermediate layer 29 are laminated. The fourth intermediate layer 29 facilitates adhesion of the fourth adhesive layer 27 and the fourth surface layer 28. A second internal space 31, which is an internal space of the second film substrate 3, is in an airtight state. The fourth adhesive layer 27 has a melting point lower than that of the fourth protective layer 26.

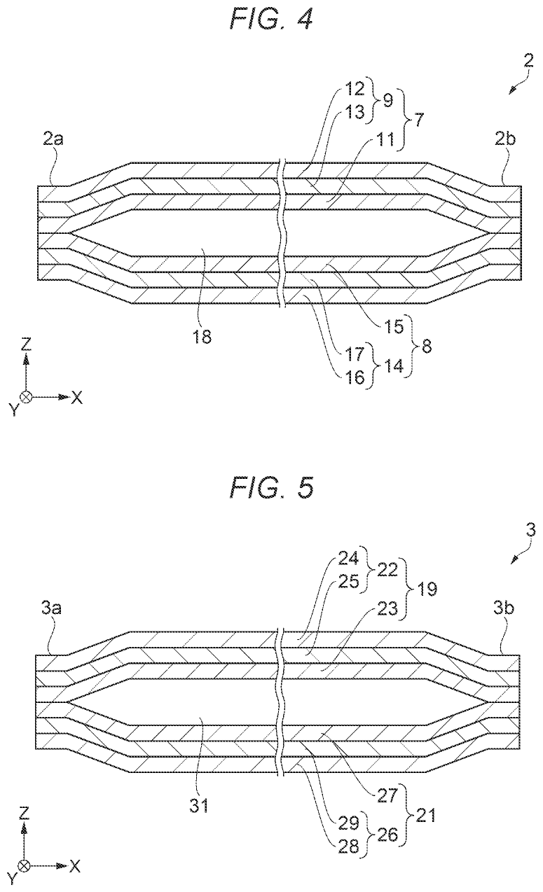

FIG. 4 is a cross-sectional view of the first film substrate 2 as viewed from the negative Y direction. As shown in FIG. 4, at the first end 2a and the second end 2b, a part of the first adhesive layer 11 of the first film 7 and a part of the second adhesive layer 15 of the second film 8 are welded in a bag shape. Since the first end 2a and the second end 2b are sealed, the first internal space 18 of the first film substrate 2 is in an airtight state.

FIG. 5 is a cross-sectional view of the second film substrate 3 as viewed from the negative Y direction. As shown in FIG. 5, at the third end 3a and the fourth end 3b, a part of the third adhesive layer 23 of the third film 19 and a part of the fourth adhesive layer 27 of the fourth film 21 are welded in a bag shape. Since the third end 3a and the fourth end 3b are sealed, the second internal space 31 of the second film substrate 3 is in an airtight state.

In the welded film laminate 1, a part of the first adhesive layer 11 and a part of the second adhesive layer 15 are welded to each other and sealed, such that the article to be packaged such as the first article to be packaged 4 or the second article to be packaged 5 is packaged between the first protective layer 9 and the second protective layer 14 of the first film substrate 2 and/or between the third protective layer 22 and the fourth protective layer 26 of the second film substrate 3. Further, in the welded film laminate 1, a part of the third adhesive layer 23 and a part of the fourth adhesive layer 27 are welded to each other and sealed.

In the present embodiment, the first article to be packaged 4 is packaged and sealed between the first protective layer 9 and the second protective layer 14 of the first film substrate 2. The second article to be packaged 5 is packaged and sealed between the third protective layer 22 and the fourth protective layer 26 of the second film substrate 3. The welded film laminate 1 may package one of the first article to be packaged 4 and the second article to be packaged 5 alone.

The first surface layer 12, the second surface layer 16, the third surface layer 24, and the fourth surface layer 28 are unlikely to be damaged. The first adhesive layer 11, the second adhesive layer 15, the third adhesive layer 23, and the fourth adhesive layer 27 have a melting point lower than that of the first protective layer 9, the second protective layer 14, the third protective layer 22, and the fourth protective layer 26, and are layers that can be easily welded when heated.

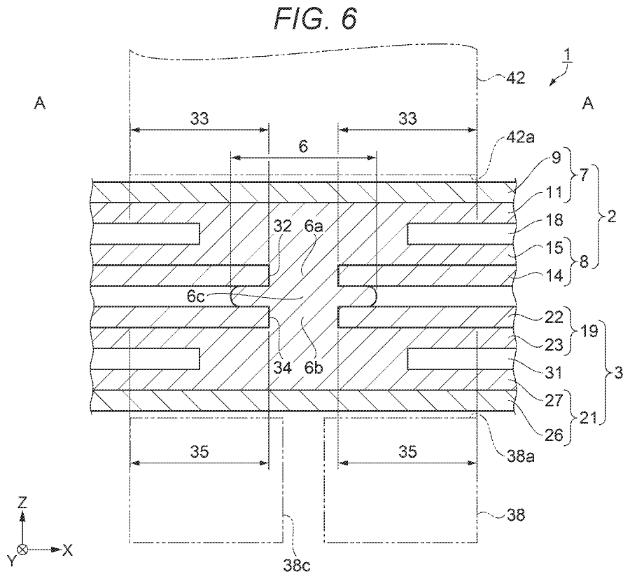

FIG. 6 is a cross-sectional view taken along line AA of FIG. 1. As shown in FIG. 6, since the third welded portion 6 has a high temperature due to a hole shape of a third hole 38c provided in the horn receiver 38, as a result, the second protective layer 14 is melted and penetrated, and a first hole 32 is formed in the second protective layer 14. The first film substrate 2 has a first welded portion 33 surrounding the first hole 32 of the second protective layer 14. At the first welded portion 33, the first adhesive layer 11 and the second adhesive layer 15 are welded to each other.

Similarly, since the third welded portion 6 has a high temperature due to the hole shape of the third hole 38c provided in the horn receiver 38, as a result, the third protective layer 22 is melted and penetrated to form a second hole 34. The first hole 32 and the second hole 34 face each other. The second film substrate 3 has a second welded portion 35 surrounding the second hole 34 of the third protective layer 22. At the second welded portion 35, the third adhesive layer 23 and the fourth adhesive layer 27 are welded to each other.

In the third welded portion 6, a part of any one of the first adhesive layer 11, the second adhesive layer 15, the third adhesive layer 23, and the fourth adhesive layer 27 is mixed through the first hole 32 and the second hole 34.

An inside of the first hole 32 in the third welded portion 6 is a first melted penetration portion 6a. An inside of the second hole 34 in the third welded portion 6 is a second melted penetration portion 6b. A portion between the first melted penetration portion 6a and the second melted penetration portion 6b in the third welded portion 6 is a welding fixed portion 6c. A portion where the adhesive layer spreads between the second protective layer 14 and the third protective layer 22 is also the third welded portion 6.

The second protective layer 14 of the first film substrate 2 and the third protective layer 22 of the second film substrate 3 are welded and fixed to each other by an adhesive layer melted out from at least one of the first adhesive layer 11 to the fourth adhesive layer 27 via the first melted penetration portion 6a of the second protective layer 14 and/or the second melted penetration portion 6b of the third protective layer 22. The adhesive layer melted out is present between the first film substrate 2 and the second film substrate 3, so that the first film substrate 2 and the second film substrate 3 are welded and fixed.

The welding fixed portion 6c is surrounded in a plan view by the first welded portion 33 in which the first adhesive layer 11 and the second adhesive layer 15 of the first film substrate 2 are welded to each other and/or the second welded portion 35 in which the third adhesive layer 23 and the fourth adhesive layer 27 of the second film substrate 3 are welded to each other. This plan view shows a view from a direction perpendicular to a surface of the first film substrate 2 in the first welded portion 33.

According to this configuration, the welding fixed portion 6c is surrounded in a plan view by the first welded portion 33 in which the first adhesive layer 11 and the second adhesive layer 15 of the first film substrate 2 are welded to each other and/or the second welded portion 35 in which the third adhesive layer 23 and the fourth adhesive layer 27 of the second film substrate 3 are welded to each other. Therefore, in a case where the first article to be packaged 4 is packaged and sealed between the first protective layer 9 and the second protective layer 14 of the first film substrate 2, the inside of the first film substrate 2 can be maintained in an airtight state even when the first melted penetration portion 6a of the first film substrate 2 is formed (melted and penetrated) to communicate with the outside (outside air). Similarly, in a case where the second article to be packaged 5 is packaged and sealed between the third protective layer 22 and the fourth protective layer 26 of the second film substrate 3, the inside of the second film substrate 3 can be maintained in an airtight state even when the second melted penetration portion 6b of the second film substrate 3 is formed (melted and penetrated) to communicate with the outside (outside air).

When the first melted penetration portion 6a and the second melted penetration portion 6b are arranged at locations facing each other (positions overlapping each other in a plan view when laminated) to constitute the welding fixed portion 6c, the inside of the first film substrate 2 and the second film substrate can be maintained in an airtight state, and the first film substrate 2 and the second film substrate 3 can be reliably welded and fixed to each other at the welding fixed portion 6c.

A part of the second protective layer 14 and a part of the third protective layer 22 may be melted at the third welded portion 6. In other words, the welding fixed portion 6c may include a part of the second protective layer 14 and a part of the third protective layer 22 that are welded to each other. The welding fixed portion 6c may include a part of the first protective layer 9 to the fourth protective layer 26. According to this configuration, since the second protective layer 14 and the third protective layer 22 are welded to each other, an adhesive force due to the welding between the second protective layer 14 and the third protective layer 22 acts on the welding fixed portion 6c in addition to an adhesive force due to the adhesive layer melted out, and thus the first film substrate 2 and the second film substrate 3 can be reliably fixed to each other.

The first adhesive layer 11, the second adhesive layer 15, the third adhesive layer 23, and the fourth adhesive layer 27 are each made of a material including polyethylene or CPP. The first protective layer 9, the second protective layer 14, the third protective layer 22, and the fourth protective layer 26 are each made of a material including PET or nylon. CPP may be replaced with polypropylene.

Polyethylene has a melting point lower than 130° C. CPP has a melting point of 138° C. PET has a melting point of 264° C., and nylon has a melting point of 215° C. The first adhesive layer 11 to the fourth adhesive layer 27 each have a melting point lower than the melting point of the first protective layer 9 to fourth protective layer 26. According to the configuration of the welded film laminate 1, the first protective layer 9, the second protective layer 14, the third protective layer 22, and the fourth protective layer 26 can form the first melted penetration portion 6a and the second melted penetration portion 6b while simultaneously forming the welding fixed portion 6c by being partially applied with a temperature higher than that of the first adhesive layer 11, the second adhesive layer 15, the third adhesive layer 23, and the fourth adhesive layer 27. The PET may be a transparent vapor-deposited PET having silicon oxide or aluminum oxide vapor-deposited on a surface thereof.

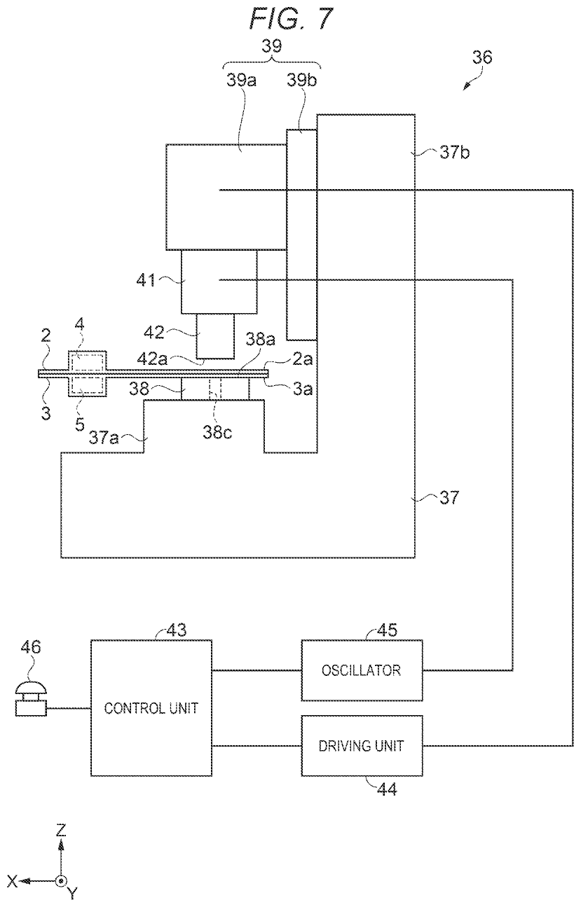

An ultrasonic welding machine 36 shown in FIG. 7 is a machine for welding the first film substrate 2 and the second film substrate 3. As shown in FIG. 7, the ultrasonic welding machine 36 includes a base 37. The base 37 includes a placement portion 37a and a support portion 37b.

The placement portion 37a has a horn receiver 38 replaceably installed thereon. The horn receiver 38 has an upper surface defined as a receiving surface 38a. The first film substrate 2 and the second film substrate 3 are arranged to overlap each other on the receiving surface 38a of the horn receiver 38. The support portion 37b stands in a direction of gravity. The support portion 37b has a surface facing the placement portion 37a installed with a linear motion mechanism 39. The linear motion mechanism 39 includes a rail 39b and a moving portion 39a. The rail 39b is installed on the support portion 37b. The linear motion mechanism 39 includes a servomotor. When the servomotor rotates, the linear motion mechanism 39 moves the moving portion 39a. The moving portion 39a moves up and down along the rail 39b. The moving portion 39a has a surface facing the placement portion 37a provided with a vibrating unit 41 thereon. The vibrating unit 41 has a surface facing the placement portion 37a installed with a horn 42.

The ultrasonic welding machine 36 includes a control unit 43, a driving unit 44, and a vibrator 45. The control unit 43 controls an operation of the ultrasonic welding machine 36. The driving unit 44 is electrically connected to the control unit and the linear motion mechanism 39. The driving unit 44 receives an instruction signal from the control unit 43 and drives the servomotor of the linear motion mechanism 39 in accordance with the instruction signal.

The control unit 43 outputs an oscillation start signal or an oscillation stop signal to an oscillator 45. The oscillator 45 includes an oscillation circuit, and forms a drive signal when receiving the oscillation start signal. The oscillator 45 outputs a drive signal to the vibrating unit 41 to drive the vibrating unit 41. The vibrating unit 41 ultrasonically vibrates the horn 42. The horn 42 has a vibrating surface 42a in contact with the first film substrate 2. Ultrasonic vibration is conducted from the vibrating surface 42a to the first film substrate 2. A start switch 46 is electrically connected to the control unit 43.

When the operator operates the start switch 46, the oscillator 45 vibrates the vibrating unit 41, so that the horn 42 vibrates. The driving unit 44 lowers the horn 42. When the horn is lowered, the first film substrate 2 and the second film substrate 3 are held between the horn 42 and the horn receiver 38. The horn 42 vibrates the first film substrate 2 and the second film substrate 3 for a predetermined time. When the predetermined time has elapsed, the oscillator 45 stops the vibration of the horn 42, and the driving unit 44 raises the horn 42.

The oscillator 45 preferably has a maximum output of 30 W or more and 50 W or less. The oscillator 45 preferably has a rated oscillation frequency of 50 kHz or more and 70 kHz or less. The horn 42 has a frequency that slightly changes according to a change in load or temperature applied to the horn 42. The oscillator 45 finely adjusts a frequency of the drive signal to be output in an automatic manner in accordance with a subtle change of the horn 42. The automatic fine adjustment of the frequency of the drive signal is referred to as automatic tracking. The oscillator 45 includes a timer, and adjusts the time for driving the vibrating unit 41 between 0.1 seconds and 7 seconds.

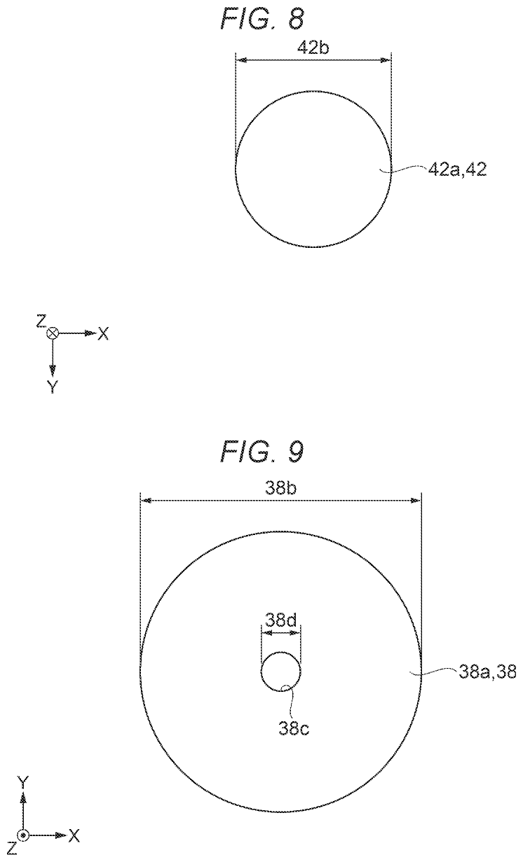

As shown in FIG. 8, the vibrating surface 42a of the horn 42 has a circular planar shape. A vibrating surface diameter 42b, which is a diameter of the vibrating surface 42a, is not particularly limited, and is, for example, 8 mm in the present embodiment. The horn 42 is made of a metallic material, for example, aluminum, titanium, or steel.

As shown in FIG. 9, the receiving surface 38a of the horn receiver 38 has a circular planar shape. A receiving surface diameter 38b, which is a diameter of the receiving surface 38a, is not particularly limited, and is, for example, 12 mm in the present embodiment. The receiving surface diameter 38b is larger than the vibrating surface diameter 42b. The horn receiver 38 is made of a metallic material, for example, stainless steel in the present embodiment.

The horn receiver 38 includes the third hole 38c as a hole at a center of the receiving surface 38a. A third diameter 38d, which is a diameter of the third hole 38c, is smaller than the vibrating surface diameter 42b. Therefore, the third hole 38c of the horn receiver 38 has an area smaller than an area of the vibrating surface 42a in the receiving surface 38a in contact with the second film substrate 3. The horn receiver 38 may include a recess instead of the third hole 38c. The third hole 38c and the recess may be recessed from the receiving surface 38a.

As shown in FIG. 6, the horn receiver 38 and the horn 42 hold the first film substrate 2 and the second film substrate 3. The horn 42 ultrasonically vibrates in a state in which the first film substrate 2 and the second film substrate 3 are pressed. The ultrasonic vibration is transmitted from the vibrating surface 42a to the first film substrate 2 and the second film substrate 3. The ultrasonic vibration causes the first film substrate 2 and the second film substrate 3 to rub against each other to generate frictional heat.

A temperature rises at the locations to become the third welded portion 6, the first welded portion 33, and the second welded portion 35. Heat accumulated in the first film substrate 2 and the second film substrate 3 is partially conducted from the receiving surface 38a and radiated to the horn receiver 38. Since the heat accumulated in the first film substrate 2 and the second film substrate 3 is not conducted in the third hole 38c, a temperature between the third hole 38c and the vibrating surface 42a is higher than that between the receiving surface 38a and the vibrating surface 42a. Specifically, a temperature between the third hole 38c and the vibrating surface 42a is 250° C. or higher, which exceeds the melting point of the second protective layer 14 and the third protective layer 22. A temperature between the periphery of the third hole 38c and the vibrating surface 42a is 130° C. or higher and 150° C. or lower, which exceeds the melting point of the first adhesive layer 11 to the fourth adhesive layer 27.

When a temperature of the second protective layer 14 and the third protective layer 22 exceeds the melting point between the third hole 38c and the vibrating surface 42a, the first hole 32 is formed in the second protective layer 14. The second hole 34 is formed in the third protective layer 22. Since the second protective layer 14 and the third protective layer 22 are made of the same material, the first hole 32 and the second hole 34 are formed at substantially the same time.

The first adhesive layer 11, the second adhesive layer 15, the third adhesive layer 23, and the fourth adhesive layer 27 have a melting point lower than that of the second protective layer 14 and the third protective layer 22. Therefore, when the first hole 32 and the second hole 34 are formed at substantially the same time, the first adhesive layer 11, the second adhesive layer 15, the third adhesive layer 23, and the fourth adhesive layer 27 are melted between the third hole 38c and the vibrating surface 42a. Therefore, the first adhesive layer 11, the second adhesive layer 15, the third adhesive layer 23, and the fourth adhesive layer 27 are mixed between the third hole 38c and the vibrating surface 42a. As a result, the third welded portion 6 is formed.

In the periphery of the third hole 38c, a temperature between the receiving surface 38a and the vibrating surface 42a is higher than the melting point of the first adhesive layer 11, the second adhesive layer 15, the third adhesive layer 23, and the fourth adhesive layer 27, and lower than the melting point of the second protective layer 14 and the third protective layer 22. Since the first adhesive layer 11, the second adhesive layer 15, the third adhesive layer 23, and the fourth adhesive layer 27 are melted, the first welded portion 33 and the second welded portion 35 are formed.

The ultrasonic welding machine 36 heats the first film substrate 2 and the second film substrate 3 at a location facing the third hole 38c to a higher temperature than that at a location facing the periphery of the third hole 38c. When the third hole 38c is replaced with a recess, the ultrasonic welding machine 36 heats the first film substrate 2 and the second film substrate 3 at a location facing the recess to a temperature higher than that at a location facing the periphery of the recess.

According to this configuration, the second protective layer 14 is melted in the location of the first film substrate 2 facing the recess of the horn receiver 38 or the third hole 38c to form the first melted penetration portion 6a. The third protective layer 22 is melted in the location of the second film substrate 3 facing the recess of the horn receiver 38 or the third hole 38c to form the second melted penetration portion 6b.

The adhesive layer can be melted out and welded via the first melted penetration portion 6a of the second protective layer and the second melted penetration portion 6b of the third protective layer 22. In the periphery of the recess of the horn receiver 38 or the third hole 38c, an internal adhesive layer can be welded without forming a hole or a penetration portion in the protective layer.

The recess or the third hole 38c has an area in a plan view of the receiving surface 38a of 1% to 80% of the area of the vibrating surface 42a. According to this configuration, the temperature of the first film substrate 2 and the second film substrate 3 at the location facing the recess or the third hole 38c can be made higher than the temperature in the periphery of the recess or the third hole 38c.

According to the configuration of the ultrasonic welding machine 36, the oscillator 45 drives the vibrating unit 41, and the vibrating unit 41 ultrasonic vibrates the horn 42. The first film substrate 2 and the second film substrate 3 are sandwiched between the horn 42 and the horn receiver 38 and are vibrated and heated. The horn receiver 38 has the recess or the third hole 38c in the receiving surface 38a, the recess or the third hole 38c having an area smaller than the area of the vibrating surface 42a. At this time, the temperature of the first film substrate 2 and the second film substrate 3 at the location facing the recess or the third hole 38c can be made higher than the temperature of the first film substrate 2 and the second film substrate 3 in the periphery of the recess or the third hole 38c.

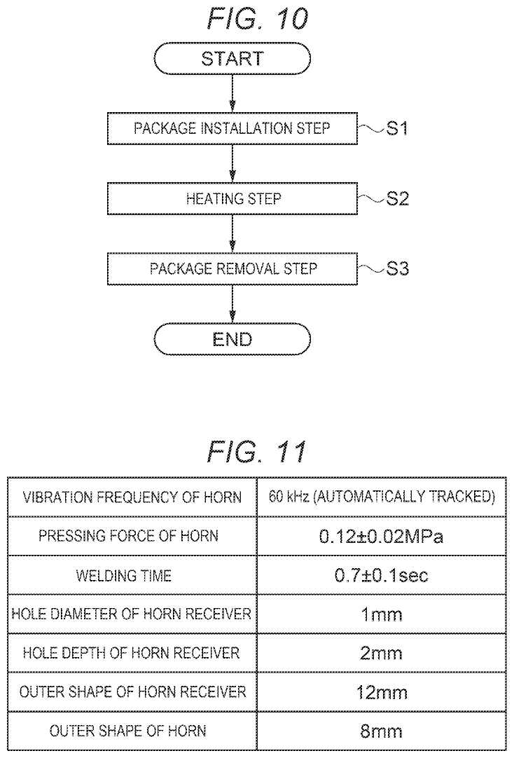

Next, a method for manufacturing the above-described welded film laminate 1 will be described with reference to FIG. 10. In the flowchart of FIG. 10, step S1 is a package installation step. In step S1, first, the first film substrate 2 and the second film substrate 3 are prepared.

In the first film substrate 2, a part of the first adhesive layer 11 of the first film 7 and a part of the second adhesive layer 15 of the second film 8 are welded to each other. In the first film 7, the first protective layer 9 and the first adhesive layer 11 are laminated. In the second film 8, the second protective layer 14 and the second adhesive layer 15 are laminated. The first adhesive layer 11 has a melting point lower than that of the first protective layer 9. The second adhesive layer 15 has a melting point lower than that of the second protective layer 14. The first article to be packaged 4 is housed in the first film substrate 2.

In the second film substrate 3, a part of the third adhesive layer 23 of the third film 19 and a part of the fourth adhesive layer 27 of the fourth film 21 are welded to each other. In the third film 19, the third protective layer 22 and the third adhesive layer 23 are laminated. In the fourth film 21, the fourth protective layer 26 and the fourth adhesive layer 27 are laminated. The third adhesive layer 23 has a melting point lower than that of the third protective layer 22. The fourth adhesive layer 27 has a melting point lower than that of the fourth protective layer 26. The second article to be packaged 5 is housed in the second film substrate 3.

The first film substrate 2 and the second film substrate 3 are arranged to overlap each other between the horn 42 having the vibrating surface 42a and the horn receiver 38 having the recess or the third hole 38c in the receiving surface 38a corresponding to the vibrating surface 42a. Next, the processing proceeds to step S2.

Step S2 is a heating step. In step S2, the ultrasonic welding machine 36 heats the first film substrate 2 and the second film substrate 3 by the vibration of the horn 42 in a state where the first film substrate 2 and the second film substrate 3 are held between the vibrating surface 42a and the receiving surface 38a. A temperature of a portion corresponding to the recess or the third hole 38c is set to be higher than the temperature of a portion corresponding to the periphery of the recess or the third hole 38c.

The ultrasonic welding machine 36 forms the welding fixed portion 6c welded and fixed by the adhesive layer melted out from a part of any one of the first adhesive layer 11 to the fourth adhesive layer 27 via the first melted penetration portion 6a penetrated by melting the first protective layer 9 and/or the second protective layer 14 of the first film substrate 2, and/or the second melted penetration portion 6b penetrated by melting the third protective layer 22 and/or the fourth protective layer 26 of the second film substrate 3 at the portion corresponding to the recess or the third hole 38c.

At a portion corresponding to the periphery of the recess or the third hole 38c, the ultrasonic welding machine 36 forms the first welded portion 33 in which the first adhesive layer 11 and the second adhesive layer 15 are welded to each other, and/or the second welded portion 35 in which the third adhesive layer 23 and the fourth adhesive layer 27 are welded to each other, such that the first welded portion 33 and/or the second welded portion 35 surround the welding fixed portion 6c.

The first melted penetration portion 6a, the second melted penetration portion 6b, the welding fixed portion 6c, the first welded portion 33, and the second welded portion 35 are formed at the same time. The first article to be packaged 4 and the second article to be packaged 5 do not overlap the welding fixed portion 6c in a plan view of the welded film laminate 1. Next, the processing proceeds to step S3.

Step S3 is a package removal step. In this step, the linear motion mechanism 39 raises the horn 42. A gap is formed between the horn receiver 38 and the horn 42. The welded film laminate 1 is removed from the ultrasonic welding machine 36. Through the above steps, the welded film laminate 1 is completed.

According to this manufacturing method, the welding fixed portion 6c is surrounded in the plan view by the first welded portion 33 in which the first adhesive layer 11 and the second adhesive layer 15 of the first film substrate 2 are welded to each other and/or the second welded portion 35 in which the third adhesive layer 23 and the fourth adhesive layer 27 of the second film substrate 3 are welded to each other. Therefore, in a case where the first article to be packaged 4 is packaged and sealed between the first protective layer 9 and the second protective layer 14 of the first film substrate 2, the inside of the first film substrate 2 can be maintained in an airtight state even when the first melted penetration portion 6a of the first film substrate 2 is formed (melted and penetrated) to communicate with the outside (outside air). Similarly, in a case where the second article to be packaged 5 is packaged and sealed between the third protective layer 22 and the fourth protective layer 26 of the second film substrate 3, the inside of the second film substrate 3 can be maintained in an airtight state even when the second melted penetration portion 6b of the second film substrate is formed (melted and penetrated) to communicate with the outside (outside air).

When the first melted penetration portion 6a and the second melted penetration portion 6b are arranged at locations facing each other (positions overlapping each other in a plan view when laminated) to constitute the welding fixed portion 6c, the inside of the first film substrate 2 and the second film substrate can be maintained in an airtight state, and the first film substrate 2 and the second film substrate 3 can be reliably welded and fixed to each other at the welding fixed portion 6c.

In the heating step of step S2, it is preferable to heat the first film substrate 2 and the second film substrate 3 to 250° C. or higher at the location facing the recess or the third hole 38c, and heat the first film substrate 2 and the second film substrate 3 at the location facing the periphery of the recess or the third hole 38c at 200° C. or lower.

According to this manufacturing method, the protective layer is melted by heating at a temperature higher than the melting point of the adhesive layer (250° C. or higher) at the location facing the recess or the third hole 38c, thereby forming the first melted penetration portion 6a and/or the second melted penetration portion 6b. At this time, the adhesive layer is heated at a temperature of the melting point of the adhesive layer (200° C. or less) at the location facing the periphery of the recess or the third hole 38c, and the first welded portion 33 is formed in the first film substrate 2 to surround the welding fixed portion 6c, and/or the second welded portion 35 is formed in the second film substrate 3 to surround the welding fixed portion 6c. Therefore, the inside of the first film substrate 2 and/or the inside of the second film substrate 3 can be maintained in an airtight state even when the first melted penetration portion 6a and/or the second melted penetration portion 6b communicate with the outside (outside air) when the first melted penetration portion 6a and/or the second melted penetration portion 6b is formed (when melted and penetrated).

Next, an example in which the welded film laminate 1 is welded by the ultrasonic welding machine 36 will be described. FIG. 11 shows one example of the operating conditions of the ultrasonic welding machine 36. In the ultrasonic welding machine 36, the frequency of the horn 42 is automatically tracked. The frequency of the horn 42 slightly changes according to a change in load or temperature applied to the horn 42. The oscillator 45 finely adjusts the frequency of the power to be output to the vibrating unit 41 in an automatic manner so as to follow a subtle change.

The horn 42 has a pressing force that can be adjusted between 0.08 Mpa and 0.2 Mpa using, for example, an air cylinder having a tube inner diameter of 6 mm. In the present embodiment, the pressing force of the horn 42 has a median value between 0.1 Mpa and 0.14 Mpa. The welding time can be adjusted, for example, between 0.4 sec and 1 sec. In the present embodiment, the welding time has a median value between 0.6 sec and 0.8 sec.

The hole diameter of the horn receiver 38 indicates the third diameter 38d of the third hole 38c. The hole diameter of the horn receiver 38 can be changed by replacing the horn receiver 38.

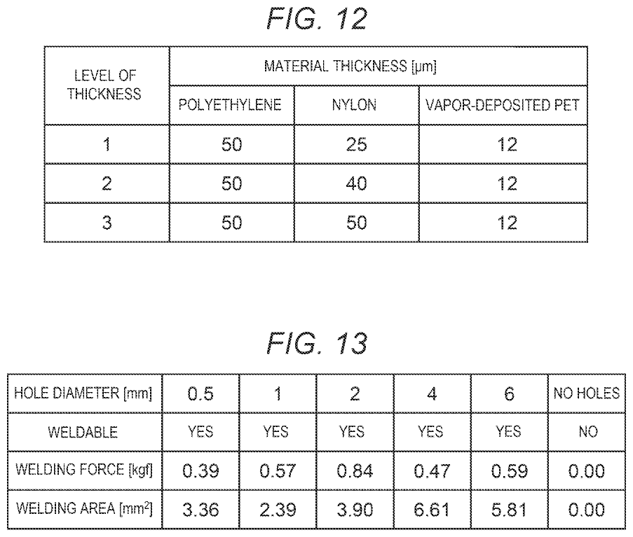

As shown in FIG. 12, polyethylene was used as the material of the first adhesive layer 11 to the fourth adhesive layer 27. The first adhesive layer 11 to the fourth adhesive layer 27 each have a thickness of 50 μm. Vapor-deposited PET was used as the material of the first surface layer 12 to the fourth surface layer 28. The first surface layer 12 to the fourth surface layer 28 each have a thickness of 12 μm. Nylon was used as the material of the first intermediate layer 13 to the fourth intermediate layer 29. The first intermediate layer 13 to the fourth intermediate layer 29 were prepared in three levels of thicknesses, that is, 25 μm, 40 μm, and 50 μm.

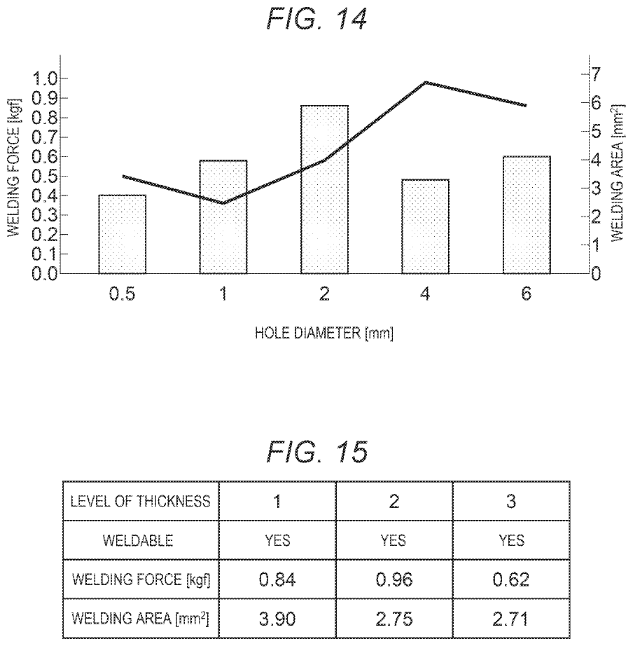

FIGS. 13 and 14 show changes in welding force between the first film substrate 2 and the second film substrate 3 when the third diameter 38d of the horn receiver 38 is changed. Each piece of data indicates an average value when the number of samples is eight. The hole diameter indicates the third diameter 38d. The welding force indicates a force required when the first film substrate 2 and the second film substrate 3 are separated from each other when the second end 2b of the first film substrate 2 and the fourth end 3b of the second film substrate 3 are pulled.

A welding possibility is evaluated by a determination value of 0.1 kgf. When the first film substrate 2 and the second film substrate 3 are separated from each other when the welded film laminate 1 is pulled based on the determination value of the welding possibility, it is determined as not weldable. When the first film substrate 2 and the second film substrate 3 are not separated from each other, it is determined as weldable.

A welding area is an area of the third welded portion 6. After the first film substrate 2 and the second film substrate 3 are separated from each other, an imaging device images the third welded portion 6. An image processing apparatus calculates the area of the third welded portion 6 by using an image of the third welded portion 6.

The third diameter 38d being in a range of 0.5 mm to 6 mm indicates that the first film substrate 2 and the second film substrate 3 are favorably welded. The range of the third diameter 38d is not particularly limited. The diameter may be changed in accordance with the material and the thickness of the first film substrate 2 and the second film substrate 3. No third hole 38c being present indicates that the first film substrate 2 and the second film substrate 3 cannot be welded. When the third diameter 38d is 0.5 mm, the area of the third hole 38c is 0.4% of the area of the vibrating surface 42a. When the third diameter 38d is 6 mm, the area of the third hole 38c is 56.3% of the area of the vibrating surface 42a. When the third diameter 38d is 7.2 mm, the area of the third hole 38c is 80% of the area of the vibrating surface 42a. Although data is not displayed, it is confirmed that the welding of the first film substrate 2 and the second film substrate 3 is favorably performed even when the third diameter 38d is 7.2 mm. Therefore, when the area of the third hole 38c is 1% to 80% of the area of the vibrating surface 42a in a plan view of the receiving surface 38a, the first film substrate 2 and the second film substrate 3 can be favorably welded.

A bar graph of FIG. 14 shows the welding force. A line graph shows the welding area. No strong correlation is present between the welding force and the welding area. When the third diameter 38d is 0.5 mm, the welding force is low as compared to the welding area. When the third diameter 38d is 1 mm, the welding area is the smallest. When the third diameter 38d is 2 mm, the welding force is the strongest, and melting out of the adhesive layer is small, which can be said as close to an optimum condition. When the third diameter 38d is 4 mm, although the welding area is the largest, the welding force is weak. As the temperature rises excessively, a hole is formed in the third welded portion 6. When the third diameter 38d is 6 mm, although the third welded portion 6 is widely welded, but is melted and is formed with a hole. When the third diameter 38d is 0.5 mm, the welding force is the lowest, but is higher than the determination value.

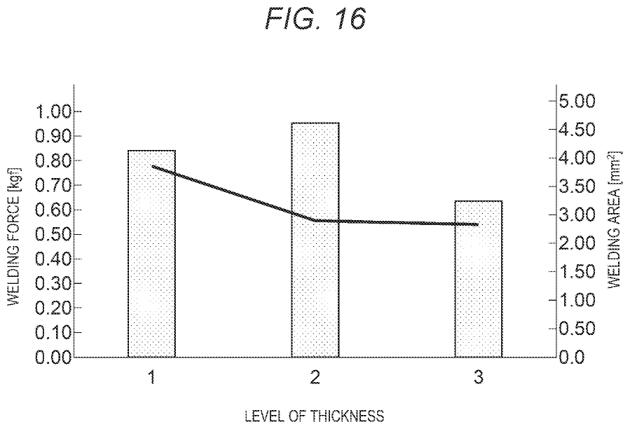

FIGS. 15 and 16 show changes in the welding force between the first film substrate 2 and the second film substrate 3 when the thickness of the intermediate layer is changed. Each piece of data indicates an average value when the number of samples is eight. The third diameter 38d of the third hole 38c is 2 mm. When the thickness of the intermediate layer is 25 μm to 50 μm, the welding force is 0.1 kgf or more, and the first film substrate 2 and the second film substrate 3 can be favorably welded.

A bar graph of FIG. 16 shows the welding force. A line graph shows the welding area. No strong correlation is present between the welding force and the welding area. When the level of the thickness is 2, the welding force is larger than when the level of the thickness is 1. At this time, the surface area is small, and the adhesion can be efficiently performed. When the level of the thickness is 2, the welding force with respect to the welding area is excellent.

### Second Embodiment

This embodiment is different from the first embodiment in that a film substrate equivalent to the first film substrate 2 is bent and welded. The same components as those of the first embodiment are denoted by the same reference numerals, and redundant description thereof will be omitted.

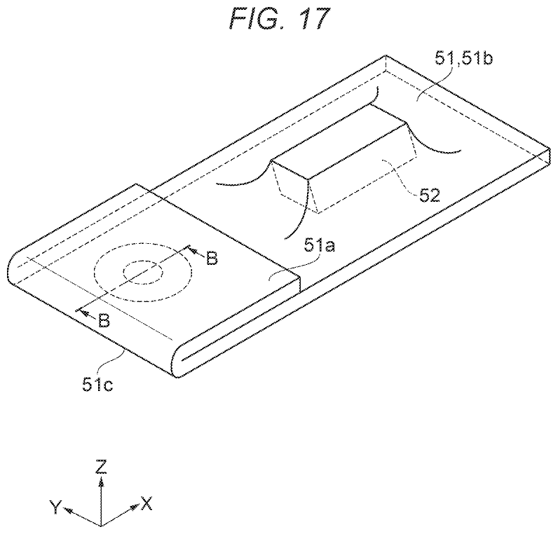

As shown in FIG. 17, a welded film laminate 51 as an object to be welded has a bag shape, and the inside of the welded film laminate 51 is sealed in an airtight state. A third article to be packaged 52 is housed inside the welded film laminate 51 as an article to be packaged. An inside of the welded film laminate 51 is depressurized. The third article to be packaged 52 is not to be wetted even if the welded film laminate 51 is put into water.

The welded film laminate 51 has a rectangular shape. One end of the welded film laminate 51 in the longitudinal direction is referred to as a first end 51a. The other end of the welded film laminate 51 in the longitudinal direction is referred to as a second end 51b. The third article to be packaged 52 is close to the second end 51b and is far from the first end 51a.

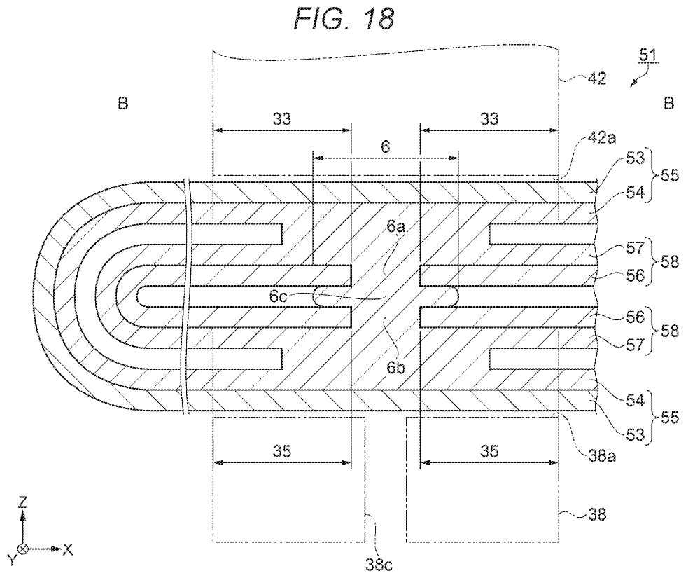

FIG. 18 is a cross-sectional view taken along line BB of FIG. 17. As shown in FIGS. 17 and 18, similarly to the first film substrate 2 of the first embodiment, the welded film laminate 51 includes a first film 55 in which a first protective layer 53 and a first adhesive layer 54 as an adhesive layer are laminated and a second film 58 in which a second protective layer 56 and a second adhesive layer 57 as an adhesive layer are laminated. A part of the first adhesive layer 54 and a part of the second adhesive layer 57 are welded to each other and sealed in a state where the third article to be packaged 52 is packaged between the first film 55 and the second film 58. The first film 55 and the second film 58 are welded to each other and sealed at the first end 51a and the second end 51b. A longitudinal direction of the welded film laminate 51 is defined as an X direction, and a width direction thereof is defined as a Y direction. A thickness direction of the welded film laminate 51 is defined as a Z direction. The welded film laminate 51 is bent into two parts in the negative X direction. A bent portion thereof is defined as a bent portion 51c.

As shown in FIG. 18, the laminated first film 55 and second film 58 are bent such that the second protective layer 56 is positioned on the inner side and is bent into two parts facing each other. One part and the other part of the bent second protective layer 56, which face each other, are welded and fixed to each other by an adhesive layer melted out from at least one of the first adhesive layer 54 and the second adhesive layer 57 via a first melted penetration portion 6a of the one part of the second protective layer 56 and/or a second melted penetration portion 6b of the other part of the second protective layer 56. In the bent second protective layer 56, the one part of the second protective layer 56 is a part of the second protective layer 56 in the positive Z direction, and the other part of the second protective layer 56 is a part of the second protective layer 56 in the negative Z direction.

The first welded portion 33 in which the first adhesive layer 54 and the second adhesive layer 57 are welded to each other is provided on a side closer to the one part of the second protective layer 56. The second welded portion 35 in which the first adhesive layer 54 and the second adhesive layer 57 are welded to each other is provided on a side closer to the other part of the second protective layer 56. The first welded portion 33 and the second welded portion 35 surround the welding fixed portion 6c in a plan view. The adhesive layer melted out from the first adhesive layer 54 and the second adhesive layer 57 is present between the one part and the other part of the bent second protective layer 56, and is welded and fixed.

According to this configuration, among the two parts facing each other of the bent second protective layer 56, the welding fixed portion 6c is surrounded in a plan view by the first welded portion 33 in which the first adhesive layer 54 provided on the side closer to the one part of the second protective layer 56 and the second adhesive layer 57 are welded, and/or the second welded portion 35 in which the first adhesive layer 54 provided on the side closer to the other part of the second protective layer 56 and the second adhesive layer 57 are welded. Therefore, the inside between the first film 55 and the second film 58, in which the third article to be packaged 52 is packaged, can be maintained in an airtight state even when the first melted penetration portion 6a of the one part of the second protective layer 56 and/or the second melted penetration portion 6b of the other part of the second protective layer 56 communicate with the outside (outside air) when the first melted penetration portion 6a and/or the second melted penetration portion 6b are formed (when melted and penetrated).

When the first melted penetration portion 6a of the one part of the second protective layer 56 and the second melted penetration portion 6b of the other part of the second protective layer 56 are arranged at locations facing each other (positions overlapping each other in a plan view when stacked) to constitute the welding fixed portion 6c, the inside of the first film 55 and the second film 58 can be maintained in an airtight state, and the two parts of the bent second protective layer 56, which are arranged facing each other, can be reliably welded and fixed to each other at the welding fixed portion 6c.

In the welded film laminate 51, it is preferable that the first adhesive layer 54 and the second adhesive layer 57 are each made of a material including polyethylene or CPP, and the first protective layer 53 and the second protective layer 56 are each made of a material including PET or nylon. CPP may be replaced with polypropylene.

Polyethylene has a melting point lower than 130° C. CPP has a melting point of 138° C. Vapor-deposited PET has a melting point of 264° C., and nylon has a melting point of 215° C. According to the configuration of the welded film laminate 51, the second protective layer 56 can form the first melted penetration portion 6a provided on the side closer to the one part of the bent second protective layer 56 and the second melted penetration portion 6b provided on the side closer to the other part of the bent second protective layer 56, which are arranged to face each other, while forming the welding fixed portion 6c, by being partially applied with a temperature higher than that of the first adhesive layer 54 and the second adhesive layer 57. The first protective layer 53 is arranged on the outer side, and can protect the welded film laminate 51.

The welding fixed portion 6c of the welded film laminate 51 preferably includes a part of the first protective layer 53 and/or the second protective layer 56. According to this configuration, in addition to the adhesive force due to the adhesive layer melted out as described above, the adhesive force of welding between the one part and the other part of the bent second protective layer 56, which face to each other, acts on the welding fixed portion 6c, so that the one part of the second protective layer 56 and the other part of the second protective layer 56 can be reliably fixed to each other in a bent state.

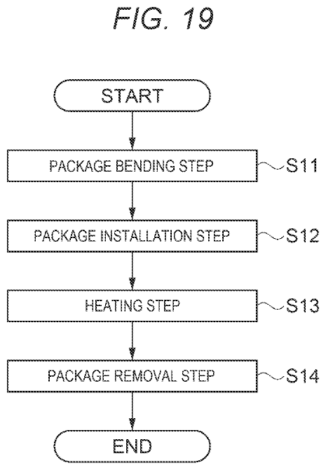

Next, a method for manufacturing the above-described welded film laminate 51 will be described with reference to FIG. 19. In the flowchart of FIG. 19, step S11 is a package bending step. In step S11, first, the welded film laminate 51 is prepared without forming the bent portion 51c. The first end 51a and the second end 51b of the welded film laminate 51 are welded to each other and sealed in a state where the third article to be packaged 52 is packaged between the first film 55 and the second film 58. In the first film 55, the first protective layer 53 and the first adhesive layer 54 are laminated. In the second film 58, the second protective layer 56 and the second adhesive layer 57 are laminated. In the welded film laminate 51, a part of the first adhesive layer 54 of the first film 55 and a part of the second adhesive layer 57 of the second film 58 are welded to each other and sealed. The welded film laminate 51 is bent such that the second protective layer 56 is positioned on the inner side and bent into two parts facing each other. Next, the processing proceeds to step S12.

Step S12 is a package installation step. In step S12, the one part and the other part of the bent second protective layer 56, which overlap in a manner of facing each other, are arranged between the horn 42 having the vibrating surface 42a and the horn receiver 38 having the recess or the third hole 38c in the receiving surface 38a corresponding to the vibrating surface 42a. Next, the processing proceeds to step S13.

Step S13 is a heating step. In step S13, in a state in which the one part and the other part of the second protective layer 56, which overlap each other, are held between the vibrating surface 42a and the receiving surface 38a, the ultrasonic welding machine 36 heats the welded film laminate 51 by the vibration of the horn 42 such that the portion corresponding to the recess or the third hole 38c is set to a temperature higher than the portion corresponding to the periphery of the recess or the third hole 38c. The temperature of the portion corresponding to the recess or the third hole 38c is set to be higher than the temperature of the portion corresponding to the periphery of the recess or the third hole 38c.

The ultrasonic welding machine 36 forms, at a portion corresponding to the recess or the third hole 38c, the welding fixed portion 6c welded and fixed by the adhesive layer melted out from a part of at least one of the first adhesive layer 54 and the second adhesive layer 57 via the first melted penetration portion 6a penetrated by melting the one part of the second protective layer 56 and/or the second melted penetration portion 6b penetrated by melting the other part of the second protective layer 56.

At the portion corresponding to the periphery of the recess or the third hole 38c, the ultrasonic welding machine 36 forms the first welded portion 33 in which the first adhesive layer 54 and the second adhesive layer 57 are welded on the side closer to the one part of the second protective layer 56, and/or the second welded portion 35 in which the first adhesive layer 54 and the second adhesive layer 57 are welded on the side closer to the other part of the second protective layer 56, such that the first welded portion 33 and the second welded portion 35 surround the welding fixed portion 6c in a plan view.

The first melted penetration portion 6a, the second melted penetration portion 6b, the welding fixed portion 6c, the first welded portion 33, and the second welded portion 35 are formed at the same time. The third article to be packaged 52 does not overlap the welding fixed portion 6c in a plan view of the welded film laminate 51. Next, the processing proceeds to step S14.

Step S14 is a package removal step. In this step, the linear motion mechanism 39 raises the horn 42. A gap is formed between the horn receiver 38 and the horn 42. The welded film laminate 51 is removed from the ultrasonic welding machine 36. Through the above steps, the welded film laminate 51 is completed.

According to this method, the welding fixed portion 6c is formed to be surrounded in a plan view by the first welded portion 33 in which the first adhesive layer 54 and the second adhesive layer 57 are welded on the side closer to the one part of the second protective layer 56 and/or the second welded portion 35 in which the first adhesive layer 54 and the second adhesive layer 57 are welded on the side closer to the other part of the second protective layer 56. Therefore, the inside between the first film 55 and the second film 58 can be maintained in an airtight state even when the first melted penetration portion 6a communicates with the outside (outside air) when the first melted penetration portion 6a is formed (when melted and penetrated) on the side closer to the one part of the second protective layer 56. Similarly, the inside between the first film 55 and the second film 58 can be maintained in an airtight state even when the second melted penetration portion 6b communicates with the outside (outside air) when the second melted penetration portion 6b is formed (when melted and penetrated) on the side closer to the other part of the second protective layer 56.

When the first melted penetration portion 6a of the one part of the second protective layer 56 and the second melted penetration portion 6b of the other part of the second protective layer 56 are arranged at locations facing each other (positions overlapping each other in a plan view when stacked) to constitute the welding fixed portion 6c, the inside of the first film 55 and the second film 58 can be maintained in an airtight state, and the two parts of the bent second protective layer 56, which are arranged facing each other, can be reliably welded and fixed to each other at the welding fixed portion 6c.

### Third Embodiment

In the first embodiment, the layers of the first film substrate 2 and the second film substrate 3 are a combination of polyethylene, CPP, nylon, and PET. Alternatively, the layers of the first film substrate 2 and the second film substrate 3 may also be a combination of oriented polypropylene (OPP), cast non-oriented polypropylene (CPP), high-density polyethylene (HDPE), low-density polyethylene (LDPE), and linear low-density polyethylene (L-LDPE). Alternatively, the layers of the first film substrate 2 and the second film substrate 3 may be a combination of polyethylene terephthalate (PET), nylon (O-NY), polyamide (PA), vinylon (PVA), polyvinyl alcohol (EVOH), and polyvinylidene chloride coating (OPP).

For example, the combination of the layers of the first film substrate 2 and the second film substrate 3 may be KOP/LDPE, ONY/LDPE, KONY/LDPE, PET/LDPE, PET/EVOH/LDPE, ONY/EVOH/LDPE, NY/EVOH/LDPE, OPP/EVOH/LDPE, or PET/aluminum vapor-deposited PET/LDPE. Alternatively, the combination of the layers of the first film substrate 2 and the second film substrate 3 may be NY/MXD/NY/LDPE, PVA-coated OPP/LDPE, OPP or PET/aluminum vapor-deposited CPP, silica vapor-deposited PET/LDPE, or alumina vapor-deposited PET/LDPE. This content can also be applied to the second embodiment.

What is claimed is:

1. A welded film laminate, comprising:
a first film substrate including a first film in which a first protective layer and a first adhesive layer having a melting point lower than that of the first protective layer are laminated, and a second film in which a second protective layer and a second adhesive layer having a melting point lower than that of the second protective layer are laminated; and
a second film substrate including a third film in which a third protective layer and a third adhesive layer having a melting point lower than that of the third protective layer are laminated, and a fourth film in which a fourth protective layer and a fourth adhesive layer having a melting point lower than that of the fourth protective layer are laminated,
parts of the adhesive layers being welded to one another and sealed such that an article to be packaged is packaged between the first protective layer and the second protective layer of the first film substrate and/or between the third protective layer and the fourth protective layer of the second film substrate, wherein
the second protective layer of the first film substrate and the third protective layer of the second film substrate are welded and fixed to each other by an adhesive layer melted out from at least one of the first adhesive layer to the fourth adhesive layer via a first melted penetration portion of the second protective layer and/or a second melted penetration portion of the third protective layer, and
a welding fixed portion in which the second protective layer and the third protective layer are welded and fixed to each other is surrounded in a plan view by a first welded portion in which the first adhesive layer and the second adhesive layer of the first film substrate are welded to each other and/or a second welded portion in which the third adhesive layer and the fourth adhesive layer of the second film substrate are welded to each other.

2. The welded film laminate according to claim 1, wherein
the first adhesive layer, the second adhesive layer, the third adhesive layer, and the fourth adhesive layer are each made of a material including polyethylene or polypropylene, and
the first protective layer, the second protective layer, the third protective layer, and the fourth protective layer are each made of a material including polyethylene terephthalate or nylon.

3. The welded film laminate according to claim 1, wherein
the welding fixing portion includes a part of the first protective layer to the fourth protective layer.

4. A welded film laminate, comprising:
a first film in which a first protective layer and a first adhesive layer having a melting point lower than that of the first protective layer are laminated; and
a second film in which a second protective layer and a second adhesive layer having a melting point lower than that of the second protective layer are laminated, wherein
a part of the first adhesive layer and a part of the second adhesive layer are welded to each other and sealed in a state in which an article to be packaged is packaged between the first film and the second film,
the laminated first film and the second film are bent such that the second protective layer is located on an inner side and is bent into two parts facing each other, and one part and the other part of the bent second protective layer, which face each other, are welded and fixed by an adhesive layer melted out from at least one of the first adhesive layer and the second adhesive layer through a first melted penetration portion of the one part of the second protective layer and/or a second melted penetration portion of the other part of the second protective layer, and
a first welded portion in which the first adhesive layer and the second adhesive layer are welded to each other is provided on a side closer to the one part of the second protective layer, and a second welded portion in which the first adhesive layer and the second adhesive layer are welded to each other is provided on a side closer to the other part of the second protective layer side, the first welded portion and the second welded portion surrounding, in a plan view, a welding fixed portion in which the one part and other part of the second protective layer are welded and fixed to each other.

5. The welded film laminate according to claim 4, wherein
the first adhesive layer and the second adhesive layer are each made of a material including polyethylene or polypropylene, and
the first protective layer and the second protective layer are each made of a material including polyethylene terephthalate or nylon.

6. The welded film laminate according to claim 4, wherein
the welding fixed portion includes a part of the first protective layer and/or the second protective layer.

7. An ultrasonic welding machine, comprising:
a horn having a vibrating surface configured to be in contact with an object to be welded;
a vibrating unit configured to ultrasonically vibrate the horn;
a vibrator configured to drive the vibrating unit; and
a horn receiver configured to hold the object to be welded together with the horn, wherein
the horn receiver has a recess or a hole in a receiving surface to be in contact with the object to be welded, the recess or hole having an area smaller than an area of the vibrating surface.

8. The ultrasonic welding machine according to claim 7, wherein
the object to be welded is heated at a location facing the recess or the hole to a temperature higher than a location facing the periphery of the recess or the hole.

9. The ultrasonic welding machine according to claim 7, wherein
the recess or the hole has an area of 1% to 80% of the area of the vibrating surface in a plan view of the receiving surface.

10. A method for manufacturing a welded film laminate, comprising:
preparing a first film substrate including a first film in which a first protective layer and a first adhesive layer having a melting point lower than that of the first protective layer are laminated, and a second film in which a second protective layer and a second adhesive layer having a melting point lower than that of the second protective layer are laminated, a part of the first adhesive layer and a part of the second adhesive layer being welded to each other;
preparing a second film substrate including a third film in which a third protective layer and a third adhesive layer having a melting point lower than that of the third protective layer are laminated, and a fourth film in which a fourth protective layer and a fourth adhesive layer having a melting point lower than that of the fourth protective layer are laminated, a part of the third adhesive layer and a part of the fourth adhesive layer being welded to each other;
arranging the first film substrate and the second film substrate in a manner overlapping each other between a horn having a vibrating surface and a horn receiver having a recess or a hole in a receiving surface corresponding to the vibrating surface;
heating the first film substrate and the second film substrate by vibration of the horn in a state in which the first film substrate and the second film substrate are held between the vibrating surface and the receiving surface, such that a portion corresponding to the recess or the hole has a temperature higher than a portion corresponding to the periphery of the recess or the hole;
forming, at the portion corresponding to the recess or the hole, a welding fixed portion welded and fixed by an adhesive layer melted out from a part of any one of the first adhesive layer to the fourth adhesive layer via a first melted penetration portion penetrated by melting the first protective layer and/or the second protective layer of the first film substrate, and/or a second melted penetration portion penetrated by melting the third protective layer and/or the fourth protective layer of the second film substrate; and
forming, at the portion corresponding to the periphery of the recess or the hole, a first welded portion in which the first adhesive layer and the second adhesive layer are welded to each other, and/or a second welded portion in which the third adhesive layer and the fourth adhesive layer are welded to each other, the first welded portion and the second welded portion surrounding the welding fixed portion.

11. The method for manufacturing a welded film laminate according to claim 10, wherein
the first film substrate and the second film substrate are heated to 250° C. or higher at a location facing the recess or the hole, and are heated at a temperature of 200° C. or less at a location facing the periphery of the recess or the hole.

12. A method for manufacturing a welded film laminate, comprising:
preparing a welded film laminate including a first film in which a first protective layer and a first adhesive layer having a melting point lower than that of the first protective layer are laminated, and a second film in which a second protective layer and a second adhesive layer having a melting point lower than that of the second protective layer are laminated, a part of the first adhesive layer and a part of the second adhesive layer being welded to each other and sealed in a state in which an article to be packaged is packaged between the first film and the second film;
bending the welded film laminate such that the second protective layer is located on an inner side and is bent into two parts facing each other;
disposing one part and the other part of the bent second protective layer, which are overlapped in a manner of facing each other, between a horn having a vibrating surface and a horn receiver having a recess or a hole in a receiving surface corresponding to the vibrating surface;
heating the first film and the second film by vibration of the horn in a state in which the overlapped one part and other part of the second protective layer are held between the vibrating surface and the receiving surface, such that a portion corresponding to the recess or the hole has a temperature higher than a portion corresponding to the periphery of the recess or the hole;
forming, at the portion corresponding to the recess or the hole, a welding fixed portion welded and fixed by an adhesive layer melted out from a part of any one of the first adhesive layer and the second adhesive layer via a first melted penetration portion penetrated by melting the one part of the second protective layer and/or a second melted penetration portion penetrated by melting the other part of the second protective layer; and
forming, at the portion corresponding to the periphery of the recess or the hole, a first welded portion in which the first adhesive layer and the second adhesive layer are welded to each other on a side closer to the one part of the second protective layer, and/or a second welded portion in which the first adhesive layer and the second adhesive layer are welded to each other on a side closer to the other part of the second protective layer, the first welded portion and the second welded portion surrounding the welding fixed portion in a plan view.
